(19) United States
(12) Patent Application Publication
(10) Pub. No.: US 2013/0233285 A1
(43) Pub. Date: Sep. 12, 2013

(54) FILTER DEVICE

(71) Applicant: DENSO CORPORATION, Kariya-city (JP)

(72) Inventors: Katsuhisa YAMADA, Okazaki-city (JP); Masaaki TANAKA, Tsu-city (JP); Tetsuro OKAZONO, Okazaki-city (JP); Kazuki MATSUBARA, Takahama-city (JP)

(73) Assignee: DENSO CORPORATION, Kariya-city (JP)

(21) Appl. No.: 13/785,565

(22) Filed: Mar. 5, 2013

(30) Foreign Application Priority Data
Mar. 7, 2012 (JP) 2012-50340
Dec. 18, 2012 (JP) 2012-275822

(51) Int. Cl. F02M 25/00

(52) U.S. Cl. CPC F02M 25/00
USPC 123/514

(57) ABSTRACT

A filter device has a sub-tank to be provided in a fuel tank. The sub-tank has an outer tubular portion and a bottom wall. A communication hole is formed in the bottom wall. An upper-side filter element is fixed to an upper side of the bottom wall to form an upper-side filter space between them, while a lower-side filter element is fixed to a lower side of the bottom wall to form a lower-side filter space between them. An inlet port of a fuel pump is connected to the upper-side filter element. Apart of fuel can be reserved in a fuel holding portion of the inside of the sub-tank and/or in the upper-side filter space, even when fuel amount in the fuel tank is decreased and the fuel tank is inclined with respect to a horizontal line.

### CROSS REFERENCE TO RELATED APPLICATION

This application is based on Japanese Patent Application No. 2012-050340 filed on Mar. 7, 2012, and No. 2012-275822 filed on Dec. 18, 2012, the disclosures of which are incorporated herein by reference.

### FIELD OF TECHNOLOGY

The present disclosure relates to a filter device for a fuel system of an engine mounted in a vehicle.

### BACKGROUND

A pump module is known in the art, according to which a fuel pump is provided in a sub-tank of a fuel tank for sucking fuel from the sub-tank to supply the fuel to an engine of a vehicle.

The pump module has a jet pump, through which a part of the fuel sucked by the fuel pump from the sub-tank is returned to the sub-tank. The fuel in the fuel tank (outside of the sub-tank) is sucked by negative pressure generated by discharge of the fuel from the jet pump, so that the fuel in the fuel tank is supplied into an inside of the sub-tank. According to such a structure, the fuel is maintained in the sub-tank so as to stably supply the fuel to the engine, even when the fuel is moved to one of sides in the fuel tank at a parking on an inclined parking place or during vehicle turning operation.

However, an amount of fuel to be sucked by the fuel pump is larger than an amount of fuel consumed in the engine by such an amount of fuel to be discharged from the jet pump. Therefore, an amount of electrical power to be consumed by the fuel pump becomes larger.

According to another type of a fuel pump module, for example, as disclosed in Japanese Patent Publication No. 2011-149397, a filter device has a bag-shaped filter element for trapping extraneous material contained in the fuel to be sucked into the fuel pump. The filter device further has a fuel reserving portion of a conical shape, which extends from an outer periphery of the filter element in an upward and a radial inward direction. According to the filter device, an oil film is formed in the filter element by surface tension of the fuel, when the filter element is immersed in the fuel. Therefore, when the fuel pump is operated, the fuel is filled in an inside of the bag-shaped filter element and the fuel is reserved in an inside of the fuel reserving portion. Accordingly, it is possible to reserve the fuel in the inside of the fuel reserving portion without using the jet pump.

However, according to the above filter device (disclosed in JP No. 2011-149397), when the operation of the fuel pump is stopped, pressure of the fuel inside of the bag-shaped filter element and the pressure of the fuel in the fuel tank become equal to each other. Then, the fuel flows out from the inside of the bag-shaped filter element to the outside of the filter element. Therefore, it is not possible to keep the fuel in the inside of the fuel reserving portion, when the operation of the fuel pump is stopped.

A wall can be provided at an inner wall of the fuel tank surrounding the fuel reserving portion for preventing the movement of the fuel (the flow-out of the fuel), in order that the fuel is kept in the fuel reserving portion at the operation stop of the fuel pump. However, such a wall increases a cost for the filter device.

In addition, according to the above filter device, the inside of the bag-shaped filter element becomes negative pressure during the operation of the fuel pump. Therefore, when an upper-side filter element and a lower-side filter element are brought into contact with each other, an amount of the fuel to be sucked into the fuel pump may be decreased. When protectors for maintaining a shape of the bag-shaped filter element are inserted into the inside of the filter element, a number of parts and components is increased. A cost for the filter device is likewise increased.

### SUMMARY OF THE DISCLOSURE

The present disclosure is made in view of the above problem. It is an object of the present disclosure to provide a filter device for a fuel system of an engine installed in a vehicle, according to which fuel can be reserved in an inside of a sub-tank when an operation of a fuel pump is stopped.

According to a feature of the present disclosure, filter elements are integrally formed with a sub-tank, wherein an upper-side filter element is fixed to an upper side of a bottom wall of the sub-tank and a lower-side filter element is fixed to a lower side of the bottom wall.

According to such a feature, a fuel reserving space is formed at least between the upper-side filter element and the bottom wall. More exactly, the fuel reserving space is formed in an inside of the sub-tank by an inner wall of a tubular portion of the sub-tank and a part of the bottom wall (which is located below a horizontal line of a communication hole formed in the bottom wall), when a fuel tank is inclined. The fuel is reserved in the fuel reserving space, even when an amount of the fuel in the fuel tank becomes smaller and the fuel tank is inclined. Therefore, oil film is formed in the upper-side filter element. In addition, oil film is formed in the lower-side filter element, so long as the lower-side filter element is immersed into the fuel. When the fuel pump is operated in such a condition, pressure in a space between the upper-side filter element and the bottom wall as well as pressure in a space between the lower-side filter element and the bottom wall becomes negative pressure. As a result, the fuel pump can suck the fuel from the inside and the outside of the sub-tank to supply the fuel to an engine.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic cross sectional view showing a filter device according to a first embodiment of the present disclosure;

FIG. 2 is a schematic top plan view when viewed in a direction of an arrow II in FIG. 1;

FIG. 3 is a schematic cross sectional view, taken along a line III-III in FIG. 4, showing a sub-tank to which the filter device of the first embodiment is applied;

FIG. 4 is a schematic cross sectional view taken along a line IV-IV in FIG. 3;

FIG. 5 is a schematic enlarged view showing relevant portions encircled by a dotted line V in FIG. 1;

FIG. 6 is a schematic view showing one of conditions for the filter device provided in a fuel tank filled with fuel;

FIG. 7 is a schematic view showing another condition for the filter device provided in the fuel tank filled with fuel;

FIG. 8 is a schematic view showing a further condition for the filter device provided in the fuel tank filled with fuel;

FIG. 9 is a schematic view showing a still further condition for the filter device provided in the fuel tank filled with fuel;

FIG. 10 is a schematic view showing one of conditions for the filter device provided in the fuel tank filled with fuel, according to a second embodiment of the present disclosure;

FIG. 11 is a schematic view showing another condition for the filter device provided in the fuel tank filled with fuel, according to the second embodiment of the present disclosure;

FIG. 12 is a schematic view showing a further condition for the filter device provided in the fuel tank filled with fuel, according to the second embodiment of the present disclosure;

FIG. 13 is a schematic view showing a still further condition for the filter device provided in the fuel tank filled with fuel, according to the second embodiment of the present disclosure;

FIG. 14 is a schematic view showing a still further condition for the filter device provided in the fuel tank filled with fuel, according to the second embodiment of the present disclosure;

FIG. 15 is a schematic view showing one of conditions for the filter device provided in the fuel tank filled with fuel, according to a third embodiment of the present disclosure;

FIG. 16 is a schematic view showing another condition for the filter device provided in the fuel tank filled with fuel, according to the third embodiment of the present disclosure;

FIG. 17 is a schematic view showing a further condition for the filter device provided in the fuel tank filled with fuel, according to the third embodiment of the present disclosure;

FIG. 18 is a schematic cross sectional view showing the filter device provided according to a fourth embodiment of the present disclosure;

FIG. 19 is a schematic top plan view when viewed in a direction of an arrow XIX in FIG. 18;

FIG. 20 is a schematic cross sectional view showing the filter device provided according to a fifth embodiment of the present disclosure;

FIG. 21 is a schematic top plan view when viewed in a direction of an arrow XXI in FIG. 20;

FIG. 22 is a schematic enlarged view showing relevant portions encircled by a dotted line XXII in FIG. 20;

FIG. 23 is a schematic cross sectional view showing the filter device provided according to a sixth embodiment of the present disclosure;

FIG. 24 is a schematic top plan view when viewed in a direction of an arrow XXIV in FIG. 23;

FIG. 25 is a schematic enlarged view showing relevant portions encircled by a dotted line XXV in FIG. 23; and

FIG. 26 is a schematic view showing one of conditions for the filter device provided in the fuel tank filled with fuel, according to a comparison example.

### DETAILED DESCRIPTION OF THE EMBODIMENTS

The present disclosure will be explained hereinafter by way of multiple embodiments. The same reference numerals are given to the same or similar portions and/or structures throughout the embodiments, for the purpose of eliminating repeated explanation.

### First Embodiment

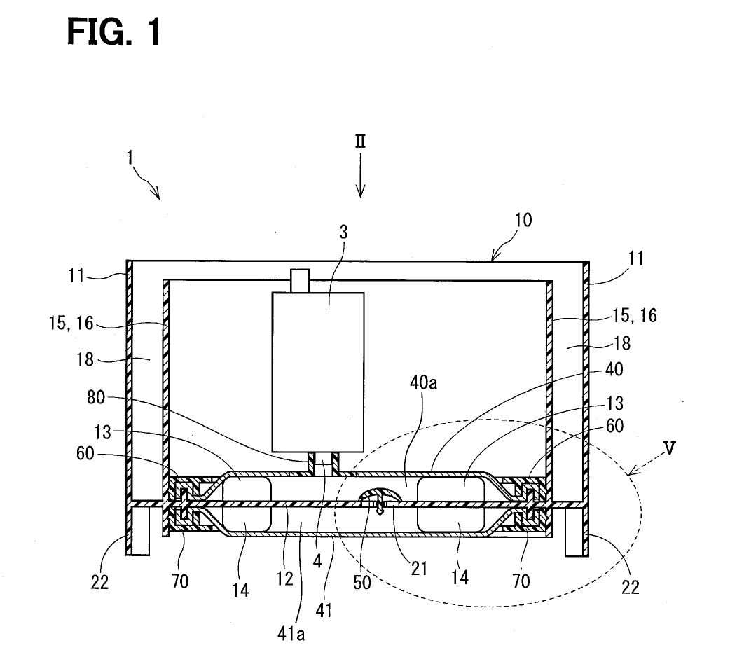

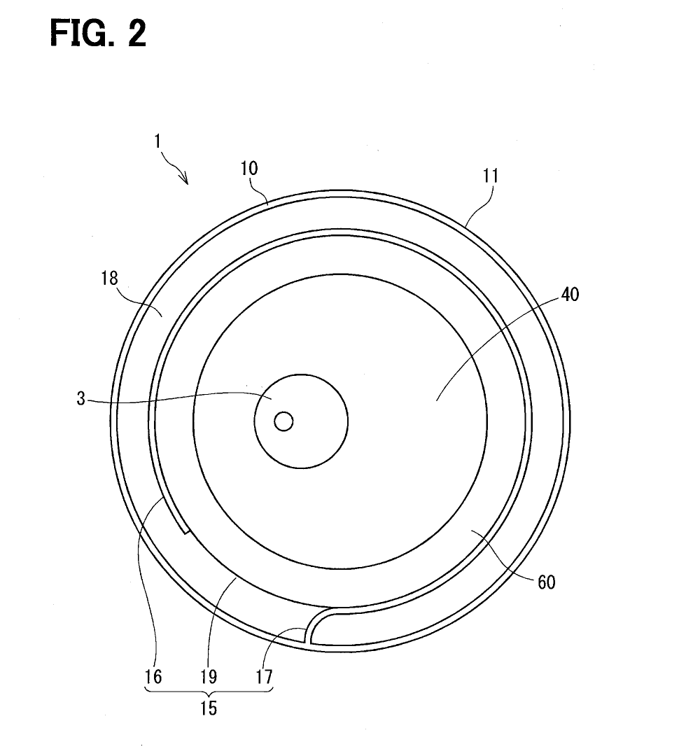

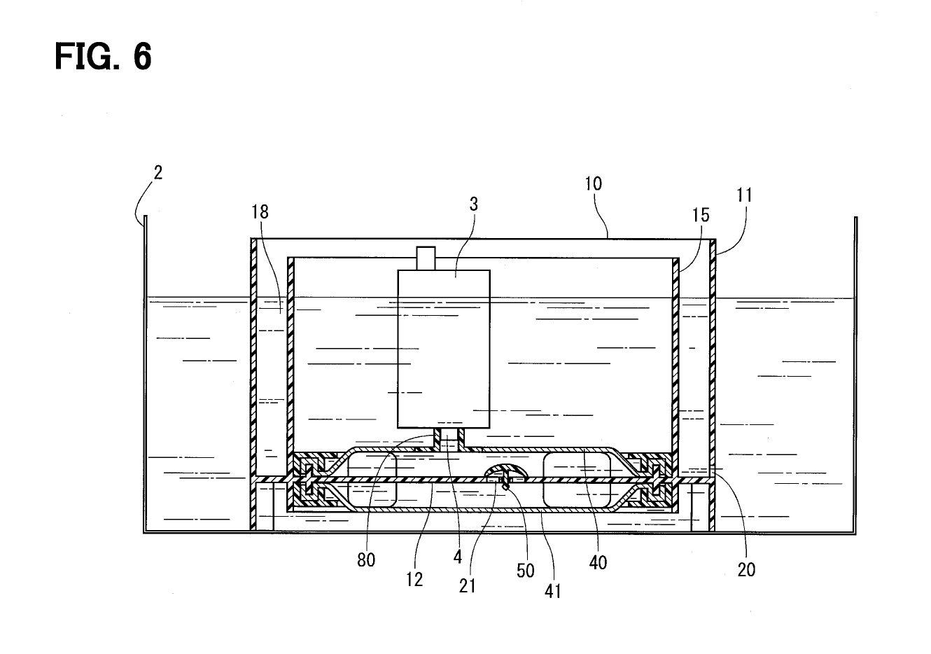

A filter device 1 according to a first embodiment of the present disclosure will be explained with reference to FIGS. 1 to 9. The filter device 1 is provided in a fuel tank 2 (FIG. 6) for catching and trapping extraneous material contained in fuel, which is sucked into a fuel pump 3 from the fuel tank 2. As shown in FIGS. 1 and 2, the filter device 1 is composed of a sub-tank 10, an upper-side filter element 40, a lower-side filter element 41, an umbrella-type valve 50 working as a check valve, an upper-side fixing member 60, a lower-side fixing member 70, a connecting pipe 80 and so on.

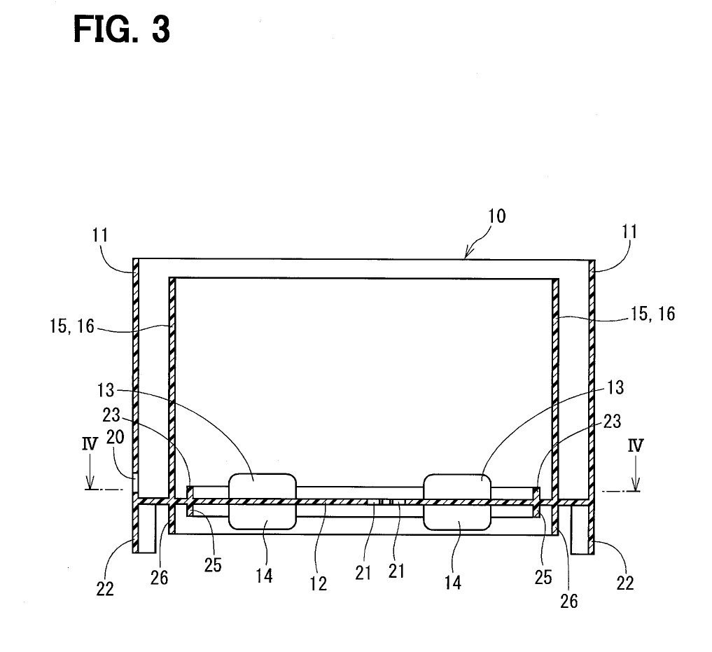

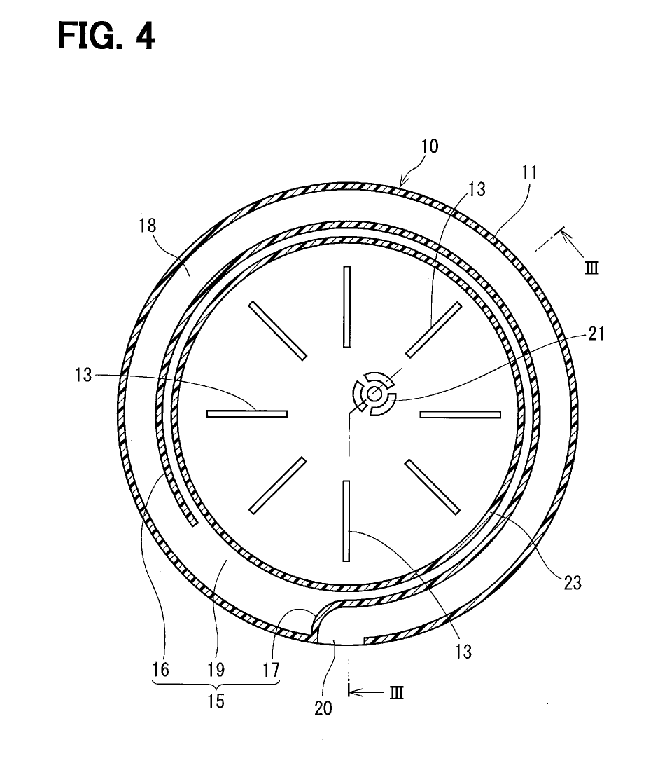

The sub-tank 10 is made of, for example, resin and formed in a tub shape. The sub-tank 10 has an outer tubular portion 11, a bottom wall 12, multiple upper-side protectors 13, multiple lower-side protectors 14, a labyrinth wall 15, a natural-flow port 20 (FIG. 4) and so on. In FIGS. 3 and 4, only the sub-tank 10 is shown for the purpose of simplicity.

The sub-tank 10 has the bottom wall 12 of a circular shape at an axial lower end of the outer tubular portion 11 of a cylindrical shape. The bottom wall 12 has communication holes 21 in its thickness direction. A leg portion 22 is formed at a lower side of the bottom wall 12. The leg portion 22 is placed on a bottom of the fuel tank 2.

Each of the upper-side protectors 13 is formed in a flat plate shape and extends from the upper side of the bottom wall 12 toward the upper-side filter element 40. In a similar manner, each of the lower-side protectors 14 is formed in a flat plate shape and extends from the lower side of the bottom wall 12 toward the lower-side filter element 41. The multiple upper-side protectors 13 as well as the multiple lower-side protectors 14 are arranged in a radial fashion (FIG. 4). A space 40a (an upper-side filter space) is formed by the upper-side protectors 13 between the bottom wall 12 and the upper-side filter element 40, while another space 41a (a lower-side filter space) is formed by the lower-side protectors 14 between the bottom wall 12 and the lower-side filter element 41. Each of the upper-side filter space 40a and the lower-side filter space 41a has such a size so as to be able to keep the fuel therein by oil films formed on a surface of the filter element by surface tension of the fuel.

The labyrinth wall 15 is composed of an inner tubular portion 16 and a blocking wall portion 17 (FIG. 2).

The inner tubular portion 16 is provided inside of the outer tubular portion 11 and formed in a C-letter shape when viewed in an axial direction. The inner tubular portion 16 and the outer tubular portion 11 are coaxially formed with each other. A labyrinth passage 18 is formed between the inner tubular portion 16 and the outer tubular portion 11.

The blocking wall portion 17 connects one circumferential end of the inner tubular portion 16 and one inner wall portion of the outer tubular portion 11. The blocking wall portion 17 closes one end of the labyrinth passage 18 so as to block fuel flow through the labyrinth passage 18 in its circumferential direction.

An opening portion 19 is formed between one circumferential end and the other circumferential end of the inner tubular portion 16 for communicating the labyrinth passage 18 to an inside space surrounded by the inner tubular portion 16.

The natural-flow port 20 is formed in the outer tubular portion 11 at such a portion, which is on an opposite side of the opening portion 19 across the blocking wall portion 17. The natural-flow port 20 is an opening for communicating the labyrinth passage 18 to the outside of the sub-tank 10. The natural-flow port 20 may be formed in the bottom wall 12.

According to the above structure, it is possible to suppress flow-out of the fuel from an inside of the sub-tank 10 to an outside of the sub-tank 10 through the natural-flow port 20, when the sub-tank 10 is inclined with respect to a horizontal line.

The upper-side filter element 40 is fixed to the sub-tank 10 at an upper side of the bottom wall 12 and traps extraneous material contained in the fuel, which is sucked into the fuel pump 3 from the inside of the sub-tank 10. In a similar manner, the lower-side filter element 41 is fixed to the sub-tank 10 at a lower side of the bottom wall 12 and traps extraneous material contained in the fuel, which is sucked into the fuel pump 3 from the outside of the sub-tank 10 through the communication holes 21 formed in the bottom wall 12. The upper-side and the lower-side filter elements 40 and 41 are made of, for example, bonded textile. When the filter elements 40 and 41 are immersed into the fuel, oil film is formed on each surface of the respective filter elements 40 and 41 due to the surface tension of the fuel.

The upper-side filter element 40 is preferably arranged in the fuel tank 2 at such a position lower than an E-point (that is, a position at which an empty alarm lamp is emitted), which is detected by a fuel gauge (not shown).

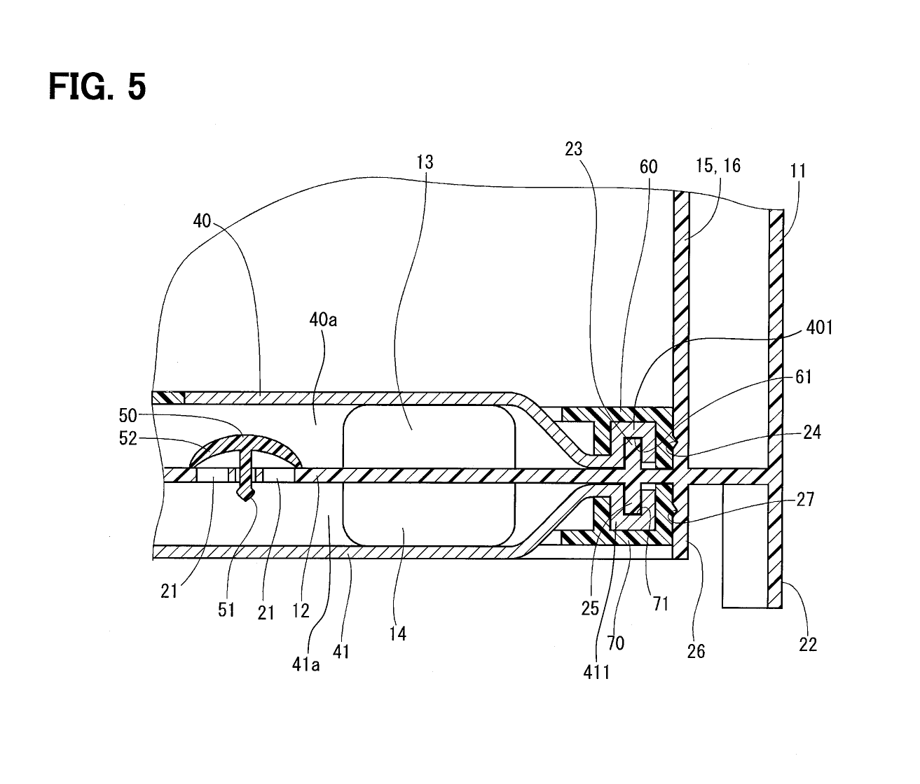

As shown in FIG. 5, the sub-tank 10 has an upper-side annular projection 23, which is formed in the bottom wall 12 at a radial-outward peripheral side of the upper-side protectors 13. The upper-side annular projection 23 is formed in a cylindrical shape and extends from the upper side of the bottom wall 12 in an axial upward direction. The upper-side fixing member 60 is formed in a ring shape and has an upper-side annular groove 61 at a position corresponding to the upper-side annular projection 23. The upper-side fixing member 60 is fitted to an upper-side annular groove 24 formed at an inner wall of the inner tubular portion 16.

An outer peripheral portion 401 of the upper-side filter element 40 is formed in a U-letter shape in its cross section. The outer peripheral portion 401 of the U-letter shape is interposed between the upper-side annular groove 61 of the upper-side fixing member 60 and the upper-side annular projection 23. As a result, the upper-side filter element 40 is firmly fixed to the sub-tank 10 at the upper side of the bottom wall 12. Since the outer peripheral portion 401 is compression-sealed, it is possible to prevent the extraneous material contained in the fuel from passing through the upper-side filter element 40 from the outside into the inside of the upper-side filter space 40a formed between the upper-side filter element 40 and the bottom wall 12.

In a similar manner, the sub-tank 10 has a lower-side annular projection 25, which is formed in the bottom wall 12 at a radial-outward peripheral side of the lower-side protectors 14. The lower-side annular projection 25 is formed in a cylindrical shape and extends from the lower side of the bottom wall 12 in an axial downward direction. The lower-side fixing member 70 is formed in a ring shape and has a lower-side annular groove 71 at a position corresponding to the lower-side annular projection 25. The lower-side fixing member 70 is fitted to a lower-side annular groove 27 formed at an inner wall of a guide wall portion 26, which is formed in a cylindrical shape and extends from the bottom wall 12 in the axial downward direction.

An outer peripheral portion 411 of the lower-side filter element 41 is formed in a U-letter shape in its cross section. The outer peripheral portion 411 of the U-letter shape is interposed between the lower-side annular groove 71 of the lower-side fixing member 70 and the lower-side annular projection 25. As a result, the lower-side filter element 41 is firmly fixed to the sub-tank 10 at the lower side of the bottom wall 12. Since the outer peripheral portion 411 is compression-sealed, it is possible to prevent the extraneous material contained in the fuel from passing through the lower-side filter element 41 from the outside into the inside of the lower-side filter space 41a formed between the lower-side filter element 41 and the bottom wall 12.

The upper-side annular projection 23 and the lower-side annular projection 25 are respectively or collectively referred to as an annular projection. The upper-side annular groove 61 and the lower-side annular groove 71 are respectively or collectively referred to as an annular groove. The upper-side fixing member 60 and the lower-side fixing member 70 are respectively or collectively referred to as a fixing member or an annular fixing member.

The umbrella-type valve (the check valve) 50 is provided at the communication holes 21 of the bottom wall 12. The umbrella-type valve 50 has a shaft portion 51 and an umbrella portion 52. The shaft portion 51 is fitted to the bottom wall 12.

The umbrella portion 52 opens the communication holes 21 when the fuel pressure in the lower-side filter space 41a between the bottom wall 12 and the lower-side filter element 41 is higher than the fuel pressure in the upper-side filter space 40a between the bottom wall 12 and the upper-side filter element 40, so that the fuel is allowed to flow from the lower-side filter space 41a to the upper-side filter space 40a through the communication holes 21. On the other hand, the umbrella portion 52 closes the communication holes 21 when the fuel pressure in the lower-side filter space 41a is lower than that in the upper-side filter space 40a, so as to block the fuel flow from the upper-side filter space 40a to the lower-side filter space 41a.

An inlet port 4 of the fuel pump 3 is connected to the upper-side filter element 40 via the connecting pipe 80. The fuel in the upper-side filter space 40a as well as the fuel in the lower-side filter space 41a is sucked into the inlet port 4 of the fuel pump 3 via the connecting pipe 80.

It is possible to change a ratio of an upper-side flow rate and a lower-side flow rate, when the positions and inner diameters of the communication holes 21 are changed. The upper-side flow rate is a flow rate of the fuel, which is sucked into the fuel pump 3 from the inside of the sub-tank 10. The lower-side flow rate is a flow rate of the fuel, which is sucked into the fuel pump 3 from the outside of the sub-tank 10 (that is, a lower side of the sub-tank 10). When the communication holes 21 are located at positions closer to the connecting pipe 80 and the inner diameter of the respective communication holes 21 is made larger, the lower-side flow rate becomes larger than the upper-side flow rate.

An operation of the filter device 1 will be explained with reference to FIGS. 6 to 9. The fuel in the fuel tank 2 is indicated by one-dot-chain lines in FIGS. 6 to 9.

As shown in FIG. 6, when the fuel is filled into the fuel tank 2, the fuel flows into the inside of the sub-tank 10 through the natural-flow port 20 and the labyrinth passage 18. When the fuel pump 3 is operated in this condition, the fuel in the sub-tank 10 is sucked into the inlet port 4 of the fuel pump 3 through the upper-side filter element 40 and the connecting pipe 80. In addition, the fuel in the fuel tank 2 outside of the sub-tank 10 is sucked into the inlet port 4 of the fuel pump 3 through the lower-side filter element 41 and the connecting pipe 80. The fuel discharged from the fuel pump 3 is supplied to an engine (not shown). The fuel (the return fuel), which is not consumed in the engine, returns to the inside of the sub-tank 10 through a return pipe (not shown).

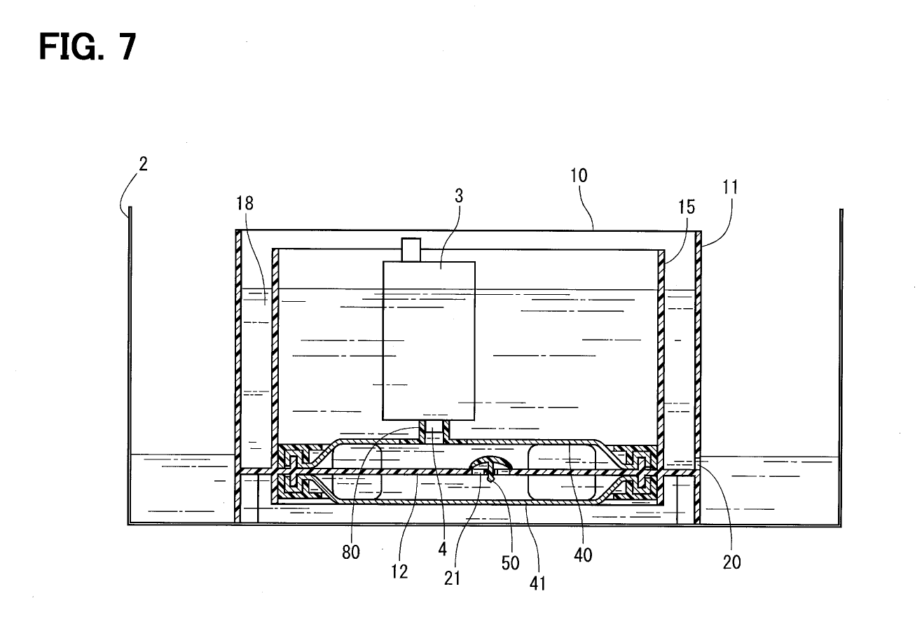

As shown in FIG. 7, when the lower-side flow rate is larger than the upper-side flow rate, the amount of the fuel inside of the sub-tank 10 becomes larger than that outside of the sub-tank 10. More exactly, the liquid level of the fuel in the inside of the sub-tank 10 becomes higher than that in the outside of the sub-tank 10. Even when the lower-side flow rate is smaller than the upper-side flow rate, the amount of the fuel inside of the sub-tank 10 also becomes larger than that outside of the sub-tank 10 (the liquid level in the sub-tank 10 becomes higher than that in the outside of the sub-tank 10), if the amount of the return fuel is larger than a difference between the upper-side flow rate and the lower-side flow rate. An inner diameter of the natural-flow port 20 is made to be such a value that a flow rate for the natural-flow port 20 is smaller than a flow rate for increasing the fuel amount in the sub-tank 10.

When the operation of the fuel pump 3 is stopped in the condition that the fuel tank 2 is in a horizontal position, the fuel flows out through the labyrinth passage 18 and the natural-flow port 20, so that the liquid level of the fuel in the sub-tank 10 and the liquid level of the fuel outside the sub-tank 10 become equal to each other.

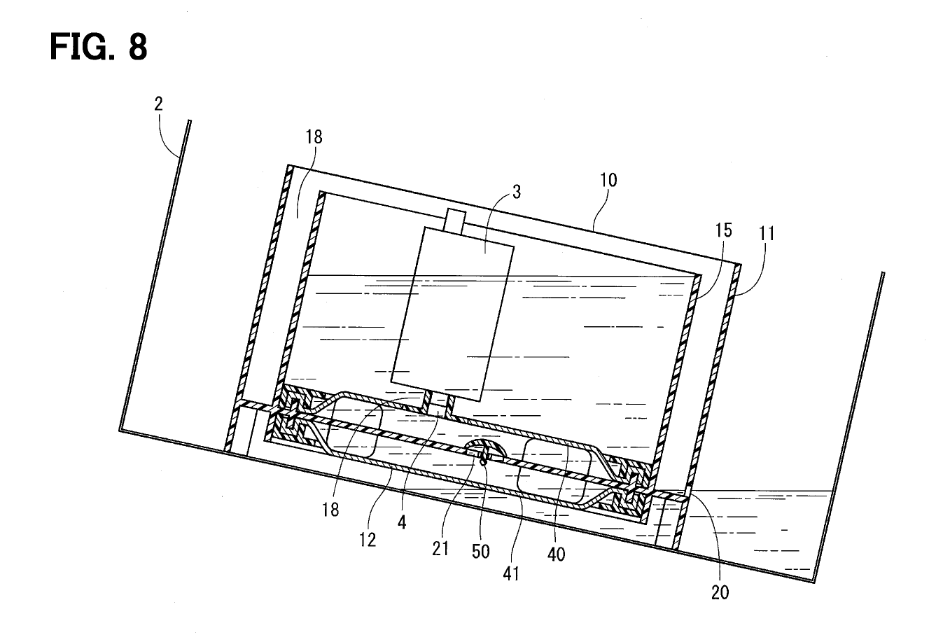

As shown in FIG. 8, during the operation of the fuel pump 3 and at a time point when the operation of the fuel pump 3 is stopped in the condition that the fuel tank 2 is inclined with respect to the horizontal line, the fuel amount inside the sub-tank 10 is larger than that outside the sub-tank 10 (the liquid level in the sub-tank 10 is higher than that outside the sub-tank 10) by the return fuel because of the labyrinth wall 15 and the umbrella-type valve 50.

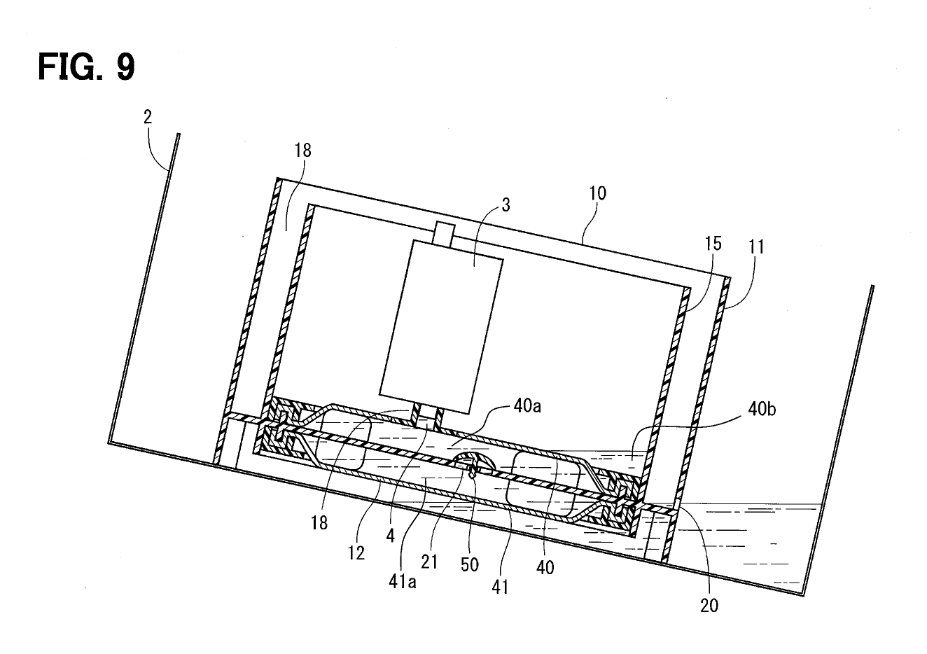

As shown in FIG. 9, during the operation of the fuel pump 3 and at the time point when the operation of the fuel pump 3 is stopped, the fuel is reserved in a fuel reserving space of the inside of the sub-tank 10 by the labyrinth wall 15 and the umbrella-type valve 50 even in a condition that the fuel amount in the fuel tank 2 becomes smaller and the fuel tank 2 is inclined with respect to the horizontal line. The fuel reserving space corresponds to such a space formed in the inside of the sub-tank 10 above the upper-side filter space 40a. In other words, the inside of the sub-tank 10 includes the upper-side filter space 40a and the fuel reserving space.

In the condition of FIG. 9, the oil film is formed on the surface of the upper-side filter element 40 due to the surface tension of the fuel inside the sub-tank 10. The oil film is also formed on the surface of the lower-side filter element 41, so long as the lower-side filter element 41 is immersed into the fuel in the fuel tank 2 (outside the sub-tank 10). The space between the upper-side filter element 40 and the lower-side filter element 41 is partitioned by the bottom wall 12 and the umbrella-type valve 50 (namely, divided into the upper-side and the lower-side filter spaces 40a and 41a). As already explained above, each of the upper-side filter space 40a and the lower-side filter space 41a has such a size so as to be able to keep the fuel therein by oil films formed on a surface of the filter element by surface tension of the fuel. Therefore, the air may not enter the upper-side and the lower-side filter spaces 40a and 41a during the operation of the fuel pump 3 and even after the operation stop of the fuel pump 3. Accordingly, the fuel can be also reserved in the upper-side and the lower-side filter spaces 40a and 41a, in addition to a portion of the fuel reserving space (which is indicated by a reference 40b and hereinafter referred to as a fuel holding portion 40b). As a result, the fuel pump 3 can suck the fuel from the inside of the sub-tank 10 and from the outside of the sub-tank 10, when the fuel pump 3 is operated.

The above explained first embodiment has the following advantages:

(1) In the first embodiment, the upper-side filter element 40 is provided at the upper side of the bottom wall 12, while the lower-side filter element 41 is provided at the lower side of the bottom wall 12. The sub-tank 10 has the labyrinth wall 15. The umbrella-type valve 50 is provided at the communication holes 21 formed in the bottom wall 12. According to the above structure, the fuel can be reserved in the inside of the sub-tank 10 during the operation of the fuel pump 3 and when the operation of the fuel pump 3 is stopped, even in the case that the fuel amount in the fuel tank 2 becomes smaller and the fuel tank 2 is inclined with respect to the horizontal line. As a result, it is possible for the fuel pump 3 to suck the fuel from the inside and the outside of the sub-tank 10.

Even when the lower-side filter element 41 is no longer immersed into the fuel outside of the sub-tank 10 (in the fuel tank 2), the fuel is still held in the inside of the sub-tank 10 (in the upper-side filter space 40a and the fuel holding portion 40b) so that the oil film in the upper-side filter element 40 is not broken. In this case, the fuel pump 3 sucks the fuel from the inside of the sub-tank 10.

(2) In the first embodiment, the upper-side filter space 40a is formed between the bottom wall 12 and the upper-side filter element 40 by the multiple upper-side protectors 13 extending from the bottom wall 12 in the upward direction. In the similar manner, the lower-side filter space 41a is formed between the bottom wall 12 and the lower-side filter element 41 by the multiple lower-side protectors 14 extending from the bottom wall 12 in the downward direction. According to such a structure, each of the upper-side and the lower-side filter elements 40 and 41 is prevented from being stuck to the bottom wall 12. It is, thereby, possible to ensure the necessary flow amount of the fuel to be sucked into the fuel pump 3.

In addition, the upper-side and the lower-side protectors 13 and 14 are integrally formed with the sub-tank 10 so as to reduce a number of working processes and thereby the manufacturing cost for the filter device 1.

(3) In the first embodiment, the filter device 1 has the umbrella-type valve (the check valve) 50. It is, thereby, possible to prevent the fuel in the inside of the sub-tank 10 from flowing out to the outside of the sub-tank 10 through the communication holes 21, when the operation of the fuel pump 3 is stopped.

In addition, it is possible to prevent the fuel from flowing out from the upper-side and the lower-side filter spaces 40a and 41a to the outside of the sub-tank 10, when the operation of the fuel pump 3 is stopped.

(4) In the first embodiment, the sub-tank 10 has the labyrinth wall 15. It is, thereby, possible to suppress the flow-out of the fuel from the inside to the outside of the sub-tank 10, when the fuel tank 2 is inclined with respect to the horizontal line.

(5) In the first embodiment, the outer peripheral portion 401 of the upper-side filter element 40 is fixed to the bottom wall 12 by the upper-side fixing member 60, while the outer peripheral portion 411 of the lower-side filter element 41 is fixed to the bottom wall 12 by the lower-side fixing member 70. As above, the upper-side and the lower-side filter elements 40 and 41 can be fixed to the bottom wall 12 in a simple manner, without using adhesion or bonding process.

### COMPARISON EXAMPLE

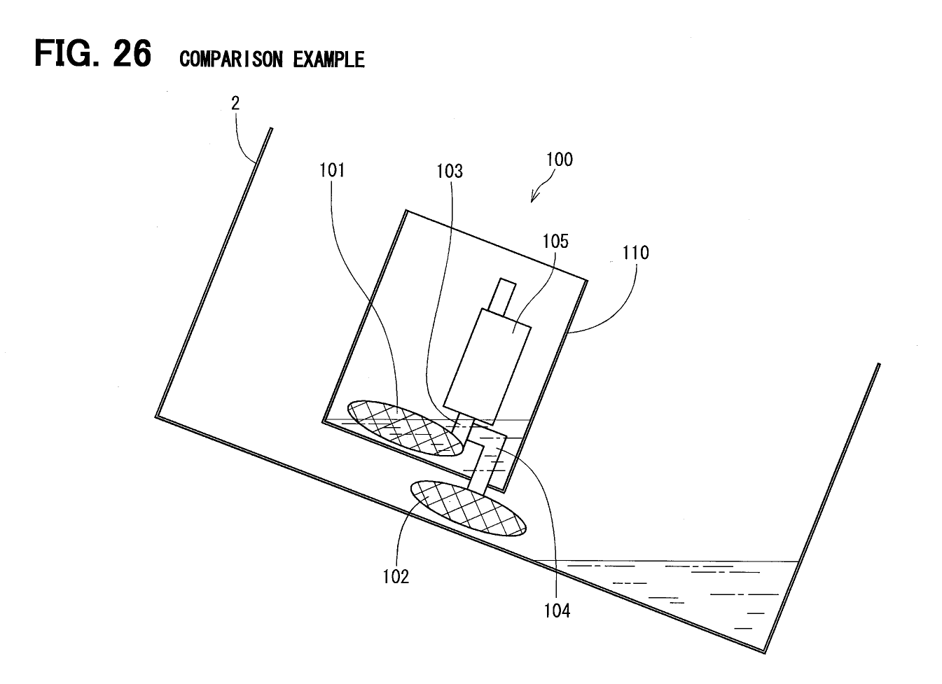

A filter device according to a comparison example will be explained with reference to FIG. 26.

A filter device 100 of the comparison example has a first filter 101 of a bag shape provided inside of a sub-tank 110 and a second filter 102 of a bag shape provided outside of the sub-tank 110. An inlet port of a fuel pump 105 is connected to the first filter 101 through a first connecting pipe 103. The second filter 102 is connected to the first connecting pipe 103 via a second connecting pipe 104.

According to the filter device 100 of the comparison example, the fuel pump 105 cannot suck the fuel when either one of the first and second filters 101 and 102 is no longer immersed into the fuel, because the oil film is broken on a filter element of such filter. In the condition shown in FIG. 26, since the second filter 102 is not immersed into the fuel (namely, since the oil film is no longer formed in the filter element of the second filter 102), the fuel pump 105 cannot suck the fuel even from the first filter 101.

In another case that the fuel is not reserved in the sub-tank 110 and thereby the first filter 101 is not immersed into the fuel in the sub-tank 110, the fuel pump 3 cannot suck the fuel, either, even when the second filter 102 is immersed into the fuel in the fuel tank 2.

### Second Embodiment

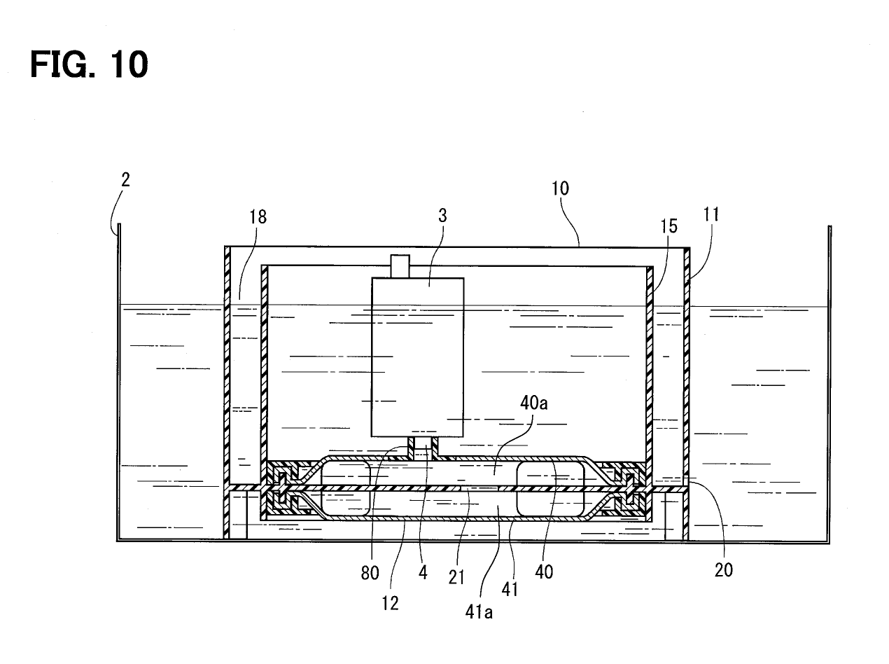

A filter device according to a second embodiment will be explained with reference to FIGS. 10 to 14.

In the filter device of the second embodiment, a valve corresponding to the umbrella-type valve 50 of the first embodiment is not provided.

As shown in FIG. 10, when the fuel is filled into the fuel tank 2, the fuel flows into the inside of the sub-tank 10 through the communication hole 21, the natural-flow port 20 and the labyrinth passage 18. The liquid level of the fuel inside of the sub-tank 10 and the liquid level of the fuel outside of the sub-tank 10 become equal to each other.

When the fuel pump 3 is operated in the above condition, the liquid level of the fuel inside of the sub-tank 10 becomes higher than that outside the sub-tank 10, as in the same manner to the first embodiment.

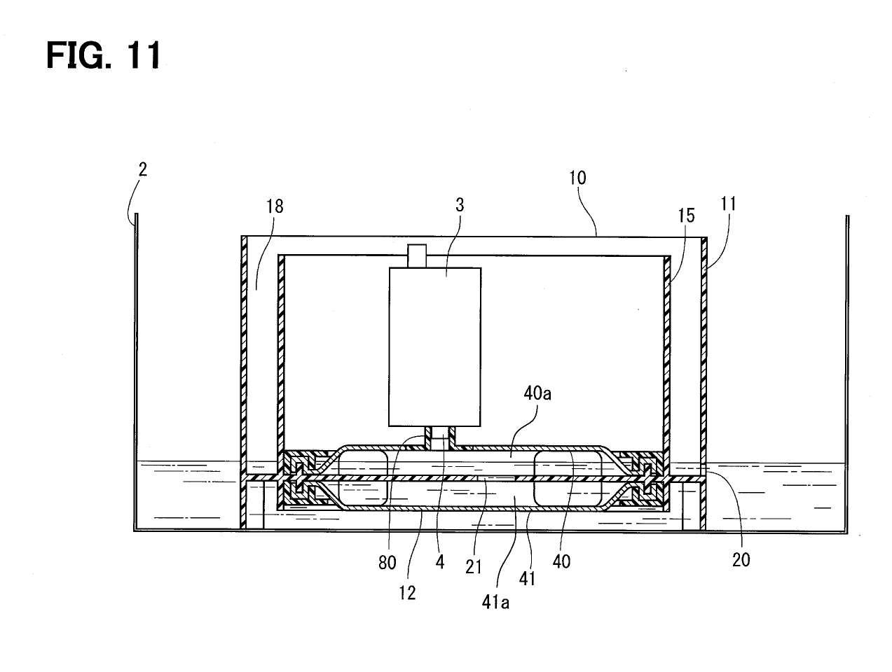

As shown in FIG. 11, when the fuel amount in the fuel tank 2 is reduced and the operation of the fuel pump 3 is stopped, the fuel flows out from the inside of the sub-tank 10 to the outside of the sub-tank 10 through the communication hole 21 and the natural-flow port 20. As a result, the liquid level of the fuel inside of the sub-tank 10 and the liquid level of the fuel outside of the sub-tank 10 become equal to each other. The oil film is formed on the surface of the upper-side filter element 40 by the surface tension of the fuel in the upper-side filter space 40a. The lower-side filter element 41 is immersed into the fuel in the fuel tank 2.

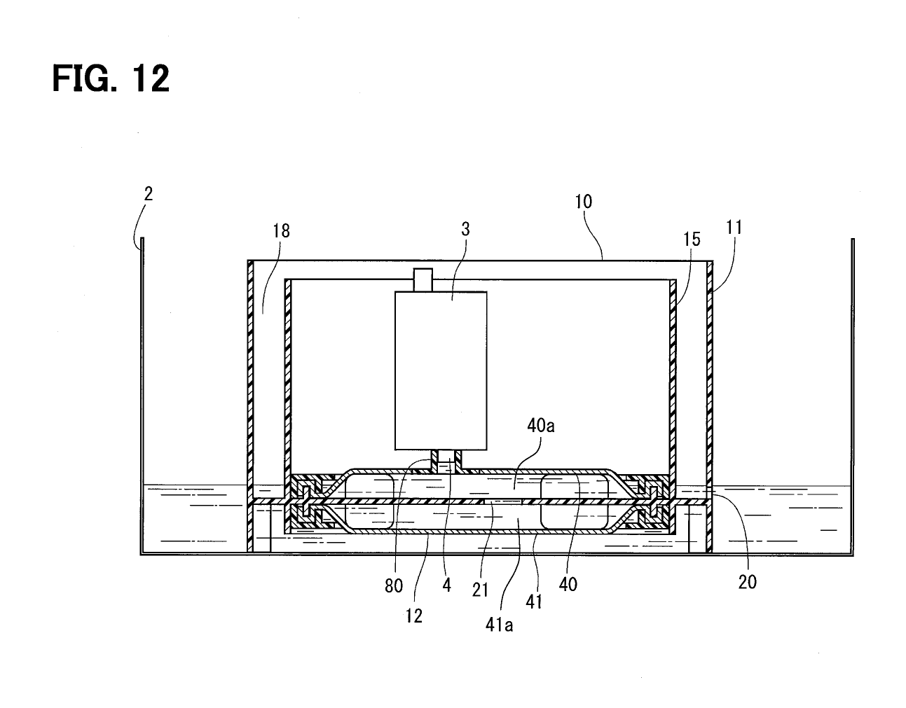

When the fuel pump 3 is operated in this condition, the air in the upper-side filter space 40a above the liquid level of the fuel is sucked into the fuel pump 3, while the air is prevented from entering the upper-side filter space 40a from the outside of the upper-side filter element 40 because of the oil film formed on the surface of the upper-side filter element 40. As a result, as shown in FIG. 12, the upper-side filter space 40a is filled with the fuel from the fuel tank 2 (from the outside of the upper-side and lower-side filter spaces 40a and 41a). As above, the fuel pump 3 sucks the fuel from the inside and outside of the sub-tank 10. After the operation of the fuel pump 3, the fuel amount in the sub-tank 10 is increased because of the return fuel.

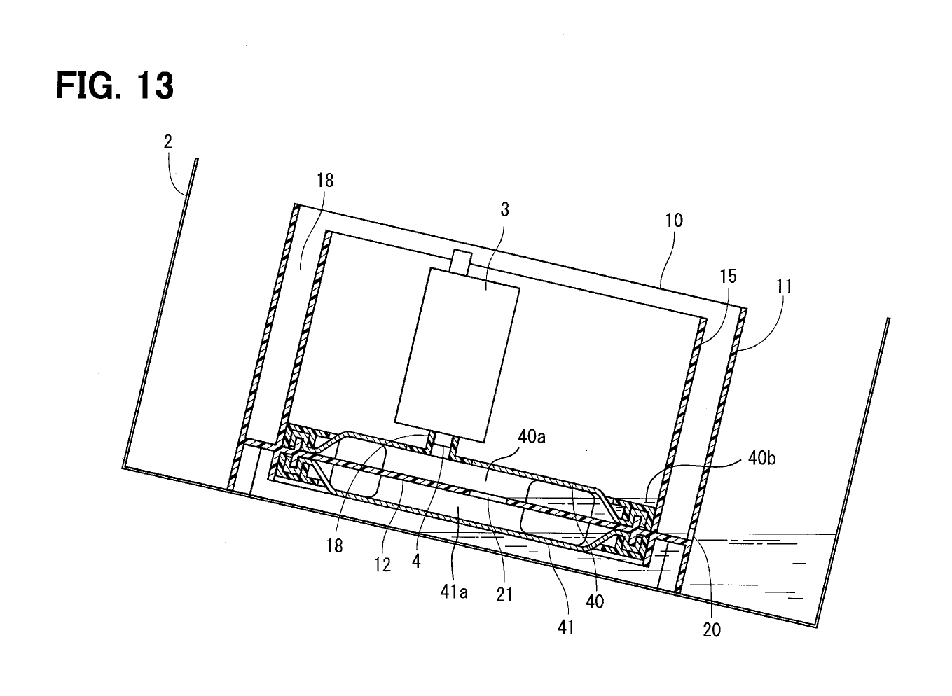

As shown in FIG. 13, when the fuel amount in the fuel tank 2 is reduced and the operation of the fuel pump 3 is stopped in a condition that the fuel tank 2 is inclined, the fuel flows out from the inside of the sub-tank 10 to the outside of the sub-tank 10 through the communication hole 21 and the natural-flow port 20. A part of the fuel, however, is maintained in the inside of the sub-tank 10 (in the fuel holding portion 40b) by the labyrinth wall 15 and a portion of the bottom wall 12, which is located below the communication hole 21 in the vertical direction in the inclined condition. Therefore, the oil film is formed on the surface of the upper-side filter element 40 by the surface tension of the fuel maintained in the inside of the sub-tank 10 (in the fuel holding portion 40b). The oil film is also formed on the surface of the lower-side filter element 41 by the surface tension of the fuel in the fuel tank 2 (the fuel outside of the sub-tank 10), so long as the lower-side filter element 41 is immersed into the fuel in the fuel tank 2.

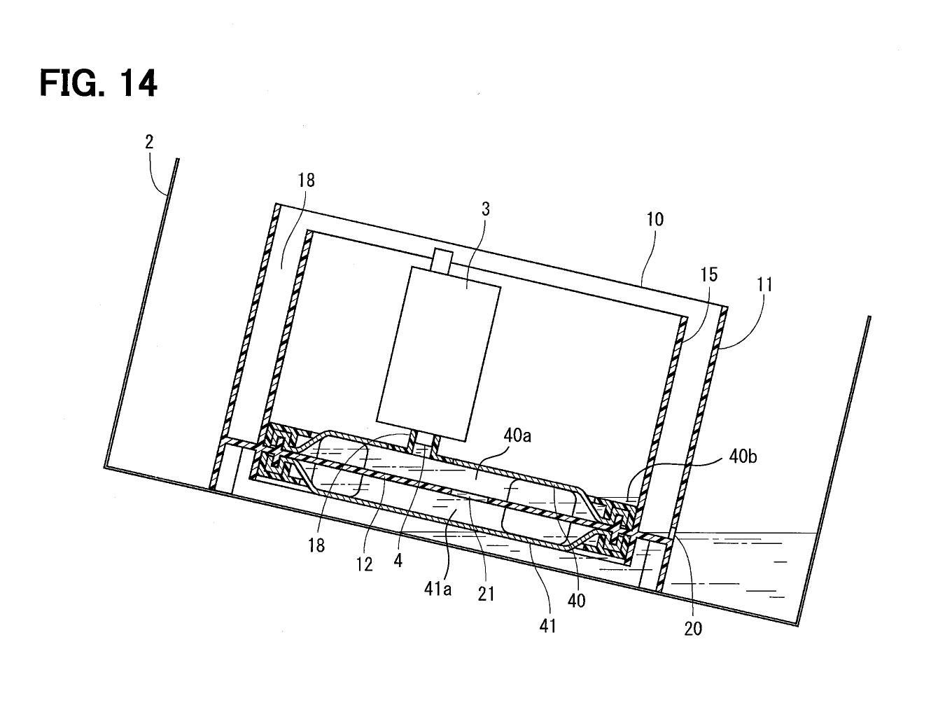

When the fuel pump 3 is operated in this condition, the air in the upper-side filter space 40a and the lower-side filter space 41a is sucked into the fuel pump 3, while the air is prevented from entering the upper-side filter space 40a from the outside of the upper-side and the lower-side filter elements 40 and 41, because of the oil films formed on the respective surfaces of the upper-side and the lower-side filter elements 40 and 41. As a result, as shown in FIG. 14, the upper-side and the lower-side filter spaces 40a and 41a are filled with the fuel from the fuel tank 2 (from the outside of the upper-side and lower-side filter spaces). As above, the fuel pump 3 can suck the fuel from the inside and outside of the sub-tank 10.

The second embodiment has the following advantages:

(1) According to the second embodiment, it is possible to reserve the part of the fuel in the fuel holding portion 40b of the inside of the sub-tank 10 surrounded by the labyrinth wall 15 and the portion of the bottom wall 12 below the communication hole 21, even when the fuel amount is reduced and the operation of the fuel pump 3 is stopped in the condition that the fuel tank 2 is inclined with respect to the horizontal line. The oil films are, therefore, formed on the surfaces of the upper-side and the lower-side filter elements 40 and 41. When the fuel pump 3 is operated in such a situation, the upper-side and the lower-side filter spaces 40a and 41a become negative pressure, so that the fuel pump 3 sucks the fuel from the inside and the outside of the sub-tank 10 to supply the fuel to the engine.

As explained above, in the filter device 100 of the comparison example shown in FIG. 26, the fuel pump 105 cannot suck the fuel when either one of the filters 101 and 102 is not immersed into the fuel. For example, when the fuel is not reserved in the sub-tank 110 and the first filter 101 is not immersed into the fuel, the fuel pump 105 cannot suck the fuel.

According to the second embodiment, however, it is possible to keep the part of the fuel in the fuel holding portion of the inside of the sub-tank 10, so that the fuel pump 3 can suck the fuel from the inside and the outside of the sub-tank 10.

(2) According to the second embodiment, the umbrella-type valve 50 is not provided. Since suction resistance is smaller in the second embodiment, it is easily possible to make the lower-side flow-rate larger than the upper-side flow-rate.

### Third Embodiment

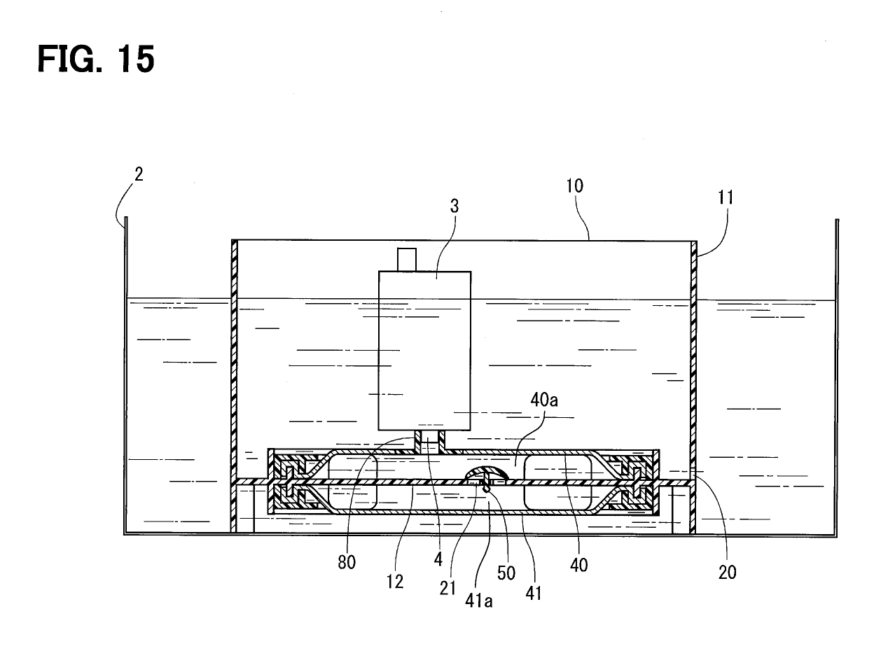

A filter device according to a third embodiment will be explained with reference to FIGS. 15 to 17.

In the third embodiment, a structure corresponding to the labyrinth wall 15 of the first embodiment is not provided. The other structure of the third embodiment is the same to that of the first embodiment.

As shown in FIG. 15, when the fuel is filled into the fuel tank 2, the fuel flows into the inside of the sub-tank 10 through the natural-flow port 20. The liquid level of the fuel inside of the sub-tank 10 and the liquid level of the fuel outside of the sub-tank 10 become equal to each other.

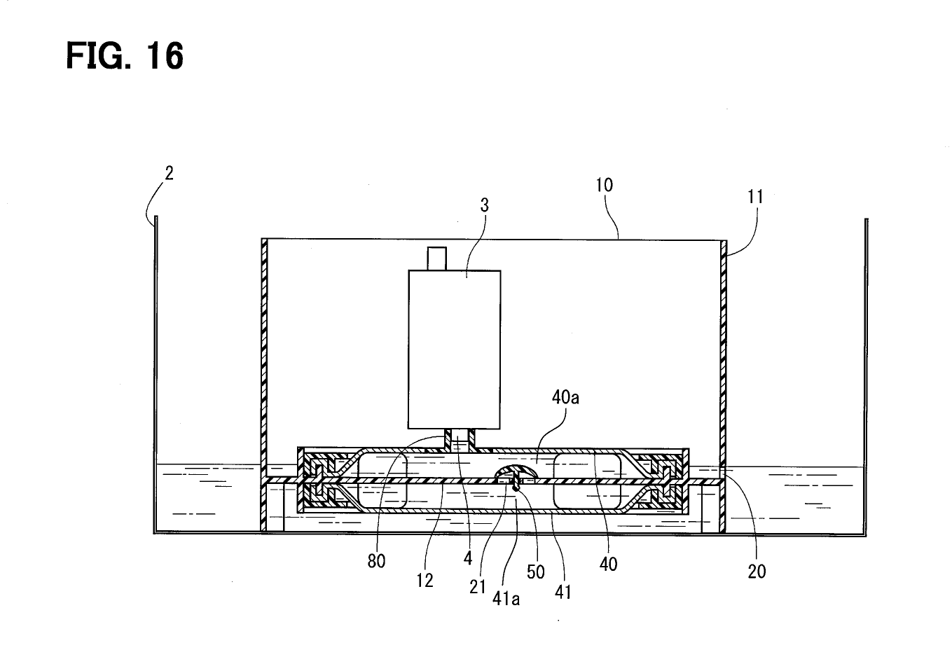

As shown in FIG. 16, when the fuel amount in the fuel tank 2 is reduced and the operation of the fuel pump 3 is stopped, the fuel flows out from the inside of the sub-tank 10 (except for the upper-side filter space 40a) to the outside of the sub-tank 10 through the natural-flow port 20. In this situation, the oil film is formed on the surface of the upper-side filter element 40 by the surface tension of the fuel in the inside of the sub-tank 10 (that is, in the upper-side filter space 40a). The lower-side filter element 41 is immersed into the fuel in the fuel tank 2. The upper-side filter space 40a and the lower-side filter space 41a are partitioned by the bottom wall 12 and the umbrella-type valve 50. The air is not allowed to enter the upper-side or the lower-side filter space 40a or 41a and the fuel is reserved in the upper-side and the lower-side filter spaces 40a and 41a between the upper-side and the lower-side filter elements 40 and 41.

When the fuel pump 3 is operated in this condition (FIG. 16), the fuel pump 3 can suck the fuel from the inside and the outside of the sub-tank 10. The fuel amount is increased after the start of the operation of the fuel pump 3 because of the return fuel.

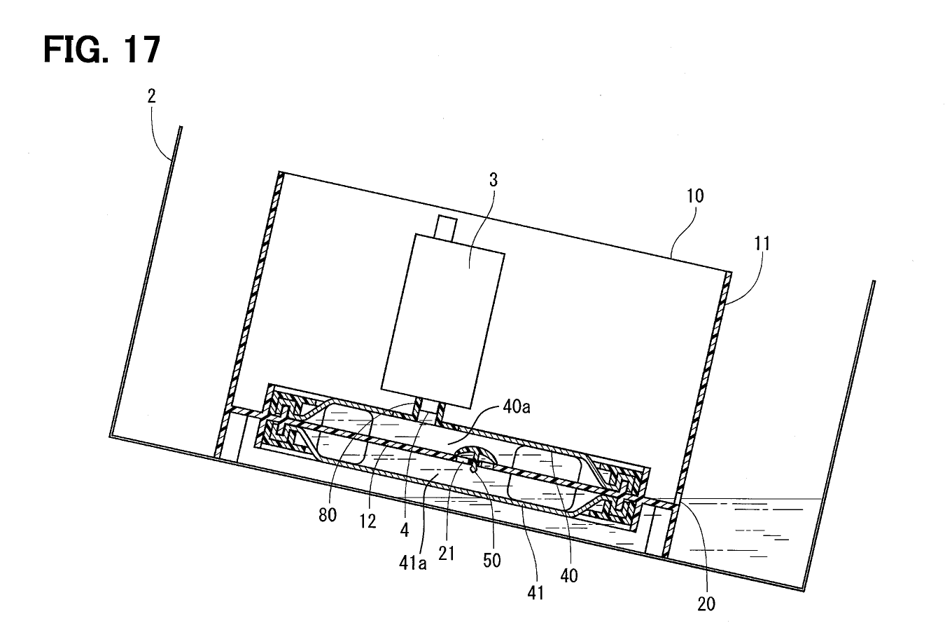

As shown in FIG. 17, when the fuel amount in the fuel tank 2 is reduced and the operation of the fuel pump 3 is stopped in a condition that the fuel tank 2 is inclined, the fuel flows out from the inside of the sub-tank 10 (except for the upper-side filter space 40a) to the outside of the sub-tank 10 through the natural-flow port 20. In this situation, since the oil films are formed on the surfaces of the upper-side and the lower-side filter elements 40 and 41, the fuel can be reserved in the upper-side and the lower-side filter spaces 40a and 41a.

When the fuel pump 3 is operated in this condition (FIG. 17), the fuel pump 3 can suck the fuel from the inside and the outside of the sub-tank 10. The fuel amount is increased thereafter in the inside of the sub-tank 10 because of the return fuel.

In the third embodiment, since the filter device 1 has the umbrella-type valve 50, it is possible to prevent the fuel from flowing out from the inside of the sub-tank 10 (more exactly, from the upper-side filter space 40a) to the outside of the sub-tank 10 through the communication hole 21, when the operation of the fuel pump 3 is stopped. It is, therefore, possible to prevent the fuel from flowing out from the upper-side and the lower-side filter spaces 40a and 41a to the outside of the sub-tank 10.

### Fourth Embodiment

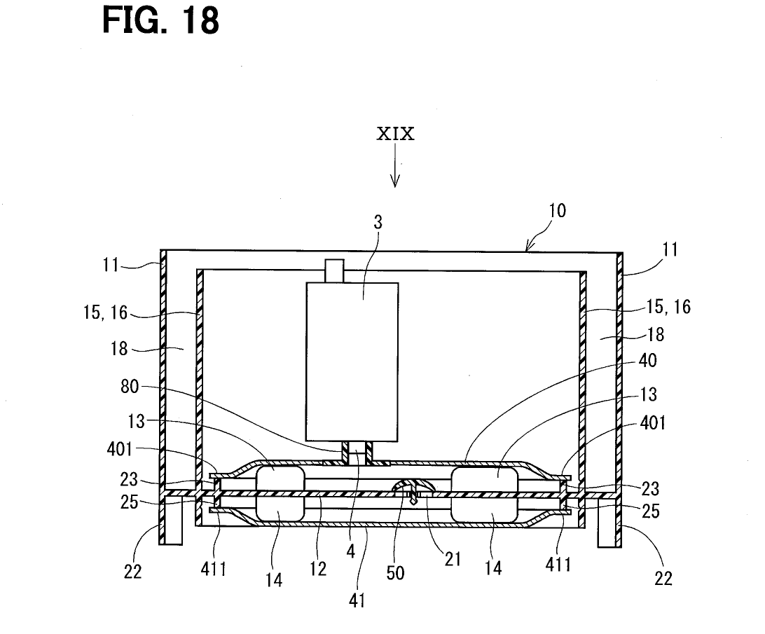

A filter device according to a fourth embodiment will be explained with reference to FIGS. 18 and 19.

According to the fourth embodiment, the outer peripheral portion 401 of the upper-side filter element 40 is fixed by welding to an upper surface of the upper-side annular projection 23, which extends from the bottom wall 12 in the upward direction. In a similar manner, the outer peripheral portion 411 of the lower-side filter element 41 is fixed by welding to a lower surface of the lower-side annular projection 25, which extends from the bottom wall 12 in the downward direction.

A welding process is carried out by well-known various kinds of welding methods, such as a heat-plate welding process, a high-frequency welding process and so on.

According to the fourth embodiment, it is possible to fix the upper-side and the lower-side filter elements 40 and 41 to the bottom wall 12 of the sub-tank 10 without using the fixing members 60 and 70 of the first to third embodiments. Therefore, a number of parts and components can be decreased to thereby reduce the manufacturing cost for the filter device.

In addition, in the fourth embodiment, each of the upper-side and the lower-side filter elements 40 and 41 is welded not to the surface of the bottom wall 12 but to the upper surface and the lower surface of the respective annular projections 23 and 25. It is, therefore, possible to concentrate heat energy of the thermal welding on the upper surface of the upper-side annular projection 23 and the lower surface of the lower-side annular projection 25. It is, thereby, possible to surely fix the upper-side and the lower-side filter elements 40 and 41 respectively to the upper-side annular projection 23 and the lower-side annular projection 25.

### Fifth Embodiment

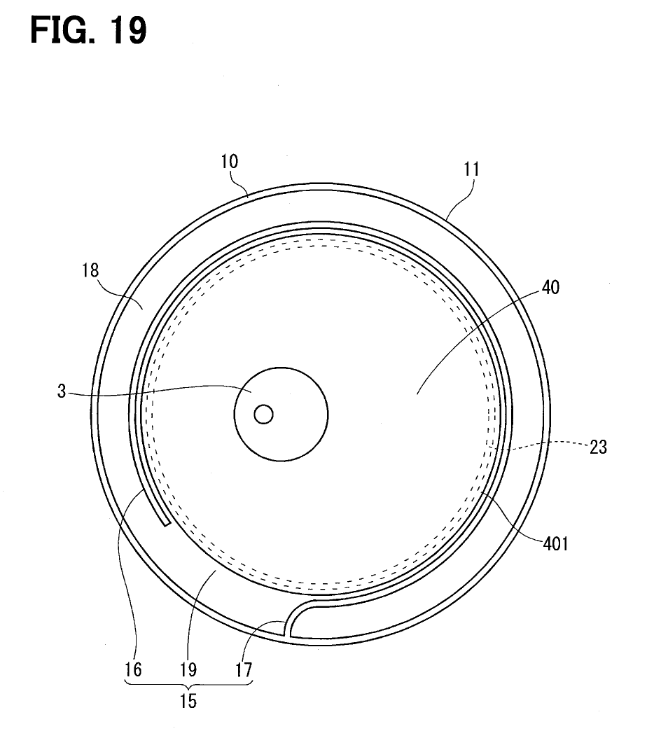

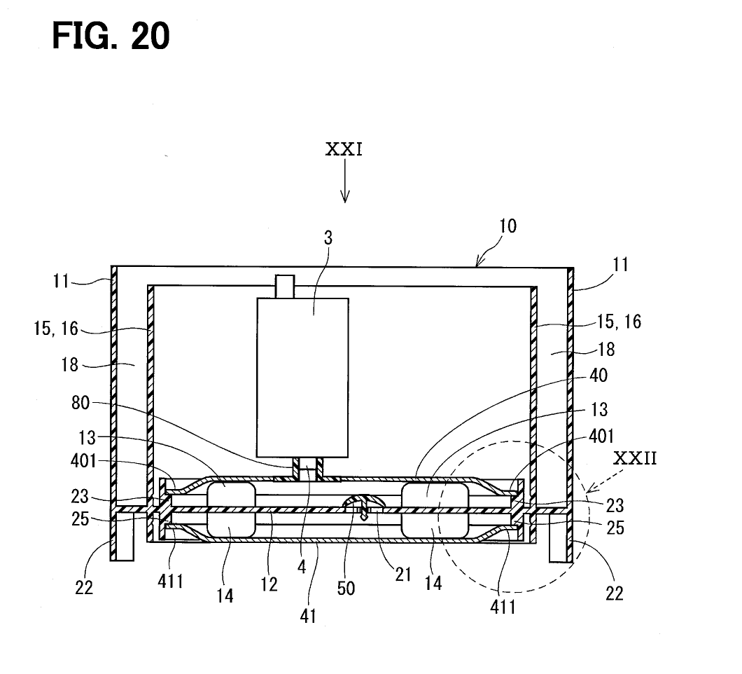

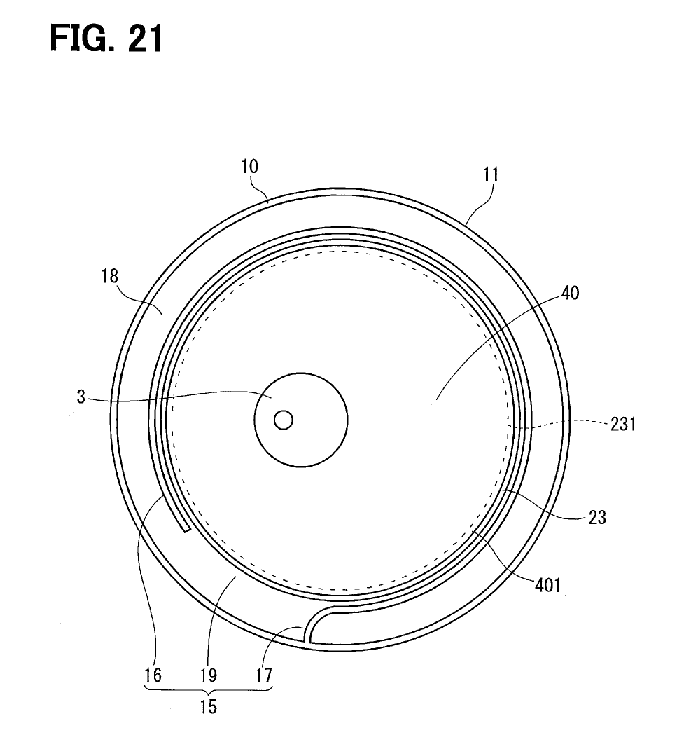

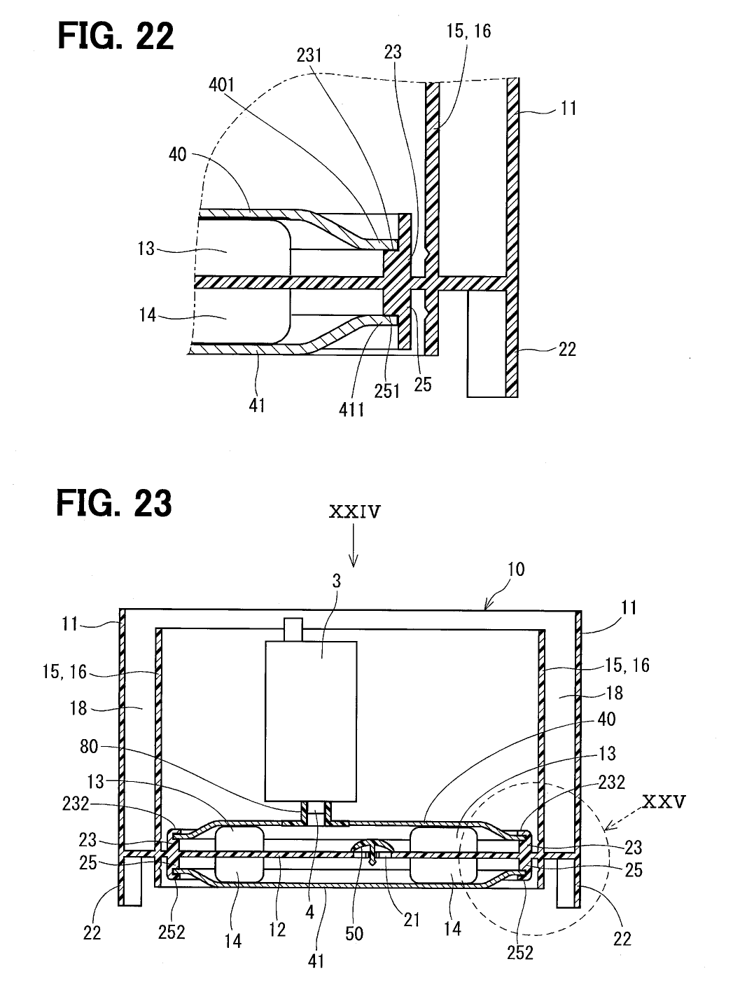

A filter device according to a fifth embodiment will be explained with reference to FIGS. 20 to 22.

According to the fifth embodiment, an upper-side step portion 231 is formed at a radial inside of the upper-side annular projection 23, wherein the upper-side step portion 231 is recessed in the downward direction. Adhesive material is applied to the upper-side step portion 231 and the outer peripheral portion 401 of the upper-side filter element 40 is stuck to the upper-side step portion 231. The upper-side filter element 40 is thus adhered to the upper-side annular projection 23.

In a similar manner, a lower-side step portion 251 is formed at a radial inside of the lower-side annular projection 25, wherein the lower-side step portion 251 is recessed in the upward direction. Adhesive material is applied to the lower-side step portion 251 and the outer peripheral portion 411 of the lower-side filter element 41 is stuck to the lower-side step portion 251. The lower-side filter element 41 is thus adhered to the lower-side annular projection 25.

During a step for applying the adhesive material to the lower-side step portion 251, the sub-tank 10 may be turned upside down in order to prevent dripping of the adhesive material.

The upper-side step portion 231 and the lower-side step portion are respectively or collectively referred to as an annular step portions.

According to the fifth embodiment, since the upper-side step portion 231 is formed at the upper-side annular projection 23 and the adhesive material is applied to the upper-side step portion 231, it is possible to hold the adhesive material on the upper-side step portion 231 by surface tension of the adhesive material. In a similar manner, the lower-side step portion 251 is formed at the lower-side annular projection 25 and the adhesive material is applied to the lower-side step portion 251. It is possible to hold the adhesive material on the lower-side step portion 251 by surface tension of the adhesive material. As a result, it is possible to surely fix (adhere) the upper-side filter element 40 to the upper-side annular projection 23 and to fix (adhere) the lower-side filter element 41 to the lower-side annular projection 25.

### Sixth Embodiment

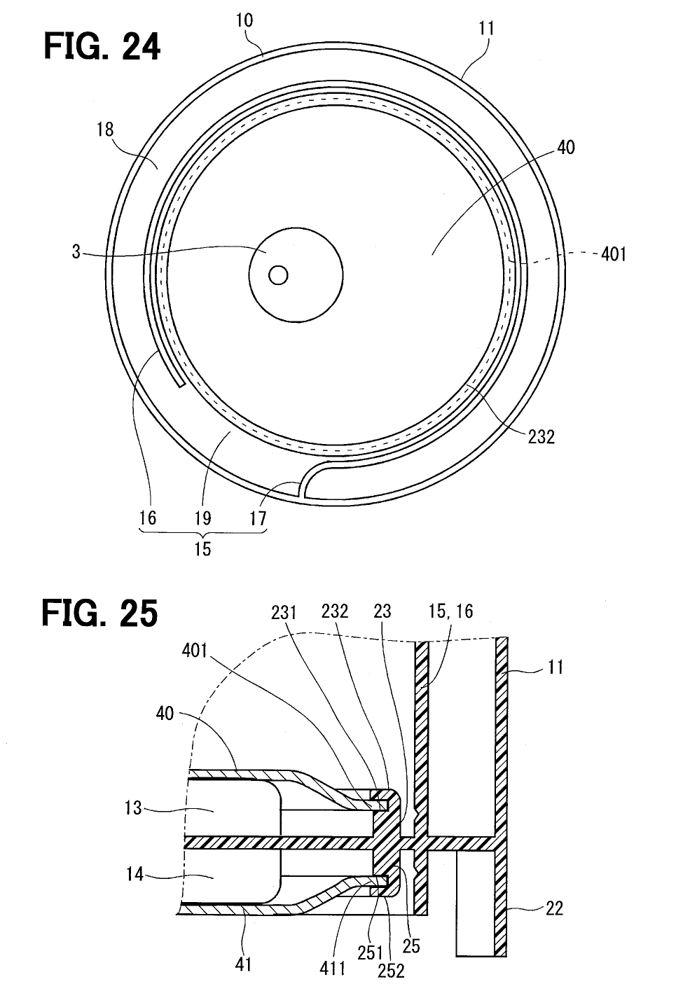

A filter device according to a sixth embodiment will be explained with reference to FIGS. 23 to 25.

According to the sixth embodiment, the upper-side step portion 231 is formed at the upper-side annular projection 23, as in the same manner to the fifth embodiment (FIGS. 20 to 22). In addition, an upper-side annular claw portion 232 is formed at the upper-side annular projection 23, wherein the upper-side annular claw portion 232 extends from the upper-side step portion 231 in the upward direction before being bent in a radial inward direction.

The upper-side filter element 40 is fixed to the upper-side annular projection 23 in the following manner. The outer peripheral portion 401 of the upper-side filter element 40 is positioned on the upper-side step portion 231. The upper-side annular claw portion 232 is heated and bent in the radial inward direction, so that the outer peripheral portion 401 of the upper-side filter element 40 is interposed between the upper-side step portion 231 and the upper-side annular claw portion 232. As a result, the outer peripheral portion 401 of the upper-side filter element 40 is compression-sealed by thermal caulking between the step portion 231 and the annular claw portion 232.

In a similar manner, the lower-side step portion 251 is formed at the lower-side annular projection 25. In addition, a lower-side annular claw portion 252 is formed at the lower-side annular projection 25, wherein the lower-side annular claw portion 252 extends from the lower-side step portion 251 in the downward direction before being bent in the radial inward direction.

The lower-side filter element 41 is fixed to the lower-side annular projection 25 in the following manner. The outer peripheral portion 411 of the lower-side filter element 41 is positioned on the lower-side step portion 251. The lower-side annular claw portion 252 is heated and bent in the radial inward direction, so that the outer peripheral portion 411 of the lower-side filter element 41 is interposed between the lower-side step portion 251 and the lower-side annular claw portion 252. As a result, the outer peripheral portion 411 of the lower-side filter element 41 is compression-sealed by thermal caulking between the step portion 251 and the annular claw portion 252.

During the above process for fixing the lower-side filter element 41 to the sub-tank 10, the sub-tank 10 may be turned upside down in order to prevent the lower-side filter element 41 from falling down from the lower-side annular projection 25.

The upper-side annular claw portion 232 and the lower-side annular claw portion 252 are respectively or collectively referred to simply as a claw portion.

In the sixth embodiment, the outer peripheral portions 401 and 411 of the upper-side and the lower-side filter elements 40 and 41 are respectively fixed to the upper-side and the lower-side annular projections 23 and 25 by thermal caulking. It is not necessary to use adhesive material and therefore the manufacturing cost can be reduced.

In addition, since the outer peripheral portions 401 and 411 of the upper-side and the lower-side filter elements 40 and 41 are respectively compression-sealed, it is possible to surely fix the upper-side and the lower-side filter elements 40 and 41 to the upper-side and the lower-side annular projections 23 and 25, respectively. As a result, it is possible to surely trap the extraneous material contained in the fuel.

### Further Embodiments and/or Modifications

(1) In the above embodiments, each of the upper-side and the lower-side filter elements is made of bonded textile. However, the filter element may be made of fabric cloth, porous resin, resin or metal of a net-like fashion and so on.

(2) In the above first to third embodiments, the upper-side annular projection 23 is formed on the upper side of the bottom wall 12 and the upper-side annular groove 61 is formed in the upper-side fixing member 60. In the same manner, the lower-side annular projection 25 is formed on the lower side of the bottom wall 12 and the lower-side annular groove 71 is formed in the lower-side fixing member 70.

However, it may be modified in the following manner: An annular groove (recessed in the downward direction) is formed on the upper side of the bottom wall and an annular projection (corresponding to the annular groove and projecting in the downward direction) is formed in the upper-side fixing member. In addition, an annular groove (recessed in the upward direction) is formed on the lower side of the bottom wall and an annular projection (corresponding to the annular groove and projecting in the upward direction) is formed in the lower-side fixing member.

(3) In the above fourth embodiment, the upper-side filter element is welded to the upper surface of the upper-side annular projection and the lower-side filter element is welded to the lower surface of the lower-side annular projection.

However, it may be modified in the following manner: The upper-side filter element is directly welded to the upper surface of the bottom wall of the sub-tank, while the lower-side filter element is directly welded to the lower surface of the bottom wall of the sub-tank.

The present disclosure should not be limited to the above embodiments and/or modifications, but can be modified in various manners without departing from the spirit of the present disclosure.

What is claimed is:

1. A filter device for trapping extraneous material contained in fuel to be sucked into a fuel pump from a fuel tank comprising:
a sub-tank provided in the fuel tank and having an outer tubular portion and a bottom wall formed at an axial lower end of the outer tubular portion, wherein a communication hole is formed in the bottom wall;
an upper-side filter element fixed to an upper side of the bottom wall for trapping extraneous material contained in the fuel to be sucked into the fuel pump from an inside of the sub-tank;
a connecting pipe for connecting the upper-side filter element to an inlet port of the fuel pump; and
a lower-side filter element fixed to a lower side of the bottom wall for trapping extraneous material contained in the fuel, which is sucked into the fuel pump from an outside of the sub-tank through the communication hole of the bottom wall.

2. The filter device according to claim 1, wherein
the sub-tank further includes;
multiple upper-side protectors, each of which extends from the upper side of the bottom wall in a direction toward the upper-side filter element so as to form an upper-side filter space between the upper-side filter element and the bottom wall; and
multiple lower-side protectors, each of which extends from the lower side of the bottom wall in a direction toward the lower-side filter element so as to form a lower-side filter space between the lower-side filter element and the bottom wall.

3. The filter device according to claim 1, further comprising:
a check valve provided at the communication hole for allowing fuel flow from the lower-side filter space to the upper-side filter space but prohibiting fuel flow from the upper-side filter space to the lower-side filter space.

4. The filter device according to claim 1, wherein
the sub-tank includes;
an inner tubular portion having a C-letter shape in a cross section perpendicular to an axial direction of the sub-tank, wherein the inner tubular portion and the outer tubular portion forms a labyrinth passage between them and wherein an opening portion is formed between circumferential ends so as to communicate the labyrinth passage to an inside space surrounded by the inner tubular portion;
a blocking wall portion formed between one of the circumferential ends of the inner tubular portion and an inner wall of the outer tubular portion for closing one end of the labyrinth passage so as to block fuel flow through the labyrinth passage in its circumferential direction; and
a natural-flow port formed in the outer tubular portion or the bottom wall at such a position close to the blocking wall portion and opposite to the opening portion across the blocking wall portion for communicating the labyrinth passage to the outside of the sub-tank.

5. The filter device according to claim 1, wherein
the sub-tank includes;
an annular projection extending from the bottom wall in an axial upward or downward direction; and
an annular fixing member having an annular grove corresponding to the annular projection,
wherein an outer peripheral portion of the upper-side or the lower-side filter element is interposed between the annular projection and the annular grove, so that the filter element is firmly fixed to the sub-tank.

6. The filter device according to claim 1, wherein
the sub-tank has an annular projection extending from the bottom wall in an axial upward or downward direction, and
an outer peripheral portion of the upper-side or the lower-side filter element is welded to the annular projection, so that the filter element is firmly fixed to the sub-tank.

7. The filter device according to claim 1, wherein the sub-tank includes;
an annular projection extending from the bottom wall in an axial upward or downward direction, and an annular step portion formed at a radial-inside of the annular projection, wherein the step portion being recessed in a direction to the bottom wall,
wherein an outer peripheral portion of the upper-side or the lower-side filter element is adhered to the annular step portion of the annular projection, so that the filter element is firmly fixed to the sub-tank.

8. The filter device according to claim 1, wherein
the sub-tank includes;
an annular projection extending from the bottom wall in an axial upward or downward direction;
an annular step portion formed at a radial-inside of the annular projection, wherein the step portion being recessed in a direction to the bottom wall; and
a claw portion extending from the annular projection at a radial-outside of the step portion, the claw portion being bent in a radial inward direction,
wherein an outer peripheral portion of the upper-side or the lower-side filter element is interposed between the annular step portion and the claw portion, so that the filter element is firmly fixed to the sub-tank.

9. A filter device for trapping extraneous material contained in fuel to be sucked into a fuel pump from a fuel tank comprising:
a sub-tank provided in the fuel tank and having an outer tubular portion and a bottom wall formed at an axial lower end of the outer tubular portion, wherein a communication hole is formed in the bottom wall;
an inner tubular portion formed in the sub-tank and having a C-letter shape in a cross section perpendicular to an axial direction of the sub-tank, wherein the inner tubular portion and the outer tubular portion forms a labyrinth passage between them and wherein an opening portion is formed between circumferential ends so as to communicate the labyrinth passage to an inside space surrounded by the inner tubular portion;
a blocking wall portion formed between one of the circumferential ends of the inner tubular portion and an inner wall of the outer tubular portion for closing one end of the labyrinth passage so as to block fuel flow through the labyrinth passage in its circumferential direction;
a natural-flow port formed in the outer tubular portion or the bottom wall at such a position close to the blocking wall portion and opposite to the opening portion across the blocking wall portion for communicating the labyrinth passage to the outside of the sub-tank;
an upper-side annular projection extending from an upper side of the bottom wall in an axial upward direction;
a lower-side annular projection extending from a lower side of the bottom wall in an axial downward direction;
an upper-side filter element fixed to the upper-side annular projection for trapping extraneous material contained in the fuel to be sucked into the fuel pump from an inside of the sub-tank, wherein the upper-side filter element and the bottom wall form an upper-side filter space;
a connecting pipe for connecting the upper-side filter element to an inlet port of the fuel pump; and
a lower-side filter element fixed to the lower-side filter element for trapping extraneous material contained in the fuel, which is sucked into the fuel pump from an outside of the sub-tank through the communication hole of the bottom wall, wherein the lower-side filter element and the bottom wall form a lower-side filter space which is communicated to the upper-side filter space through the communication hole.

10. The filter device according to claim 9, wherein
the sub-tank further includes;
multiple upper-side protectors, each of which extends from the upper side of the bottom wall in a direction toward the upper-side filter element and arranged in a radial fashion so as to maintain a shape of the upper-side filter space; and
multiple lower-side protectors, each of which extends from the lower side of the bottom wall in a direction toward the lower-side filter element and arranged in a radial fashion so as to maintain a shape of the lower-side filter space.

11. The filter device according to claim 9, further comprising:
a check valve provided at the communication hole for allowing fuel flow from the lower-side filter space to the upper-side filter space but prohibiting fuel flow from the upper-side filter space to the lower-side filter space.

12. A filter device for trapping extraneous material contained in fuel to be sucked into a fuel pump from a fuel tank comprising:
a sub-tank provided in the fuel tank and having a tubular portion and a bottom wall formed at an axial lower end of the tubular portion, wherein a communication hole is formed in the bottom wall;
a natural-flow port formed in the tubular portion or the bottom wall for communicating an inside of the sub-tank to an outside of the sub-tank;
an upper-side annular projection extending from an upper side of the bottom wall in an axial upward direction;
a lower-side annular projection extending from a lower side of the bottom wall in an axial downward direction;
an upper-side filter element fixed to the upper-side annular projection for trapping extraneous material contained in the fuel to be sucked into the fuel pump from the inside of the sub-tank, wherein the upper-side filter element and the bottom wall form an upper-side filter space;
a connecting pipe for connecting the upper-side filter element to an inlet port of the fuel pump;
a lower-side filter element fixed to the lower-side annular projection for trapping extraneous material contained in the fuel, which is sucked into the fuel pump from the outside of the sub-tank through the communication hole of the bottom wall, wherein the lower-side filter element and the bottom wall form a lower-side filter space which is communicated to the upper-side filter space through the communication hole; and
a check valve provided at the communication hole for allowing fuel flow from the lower-side filter space to the upper-side filter space but prohibiting fuel flow from the upper-side filter space to the lower-side filter space.
